(19) United States
(12) Patent Application Publication
(10) Pub. No.: US 2024/0271249 A1
(43) Pub. Date: Aug. 15, 2024

(54) Heap Leaching an Ore

(71) Applicant: Rio Tinto Technological Resources Inc., South Jordan, UT (US)

(72) Inventors: Ronald Sorensen, South Jordan, UT (US); John Richard Meloy, South Jordan, UT (US); Ralph Peter Hackl, South Jordan, UT (US); Paul Leslie Brown, South Jordan, UT (US)

(21) Appl. No.: 18/105,514

(22) Filed: Feb. 3, 2023

(51) Int. Cl. C22B 15/00; C22B 3/08; C22B 3/18

(52) U.S. Cl. CPC C22B 15/0071; C22B 3/08; C22B 3/18

(57) ABSTRACT

A method of heap leaching a metal from a mined ore that contains a metal sulfide-containing material, such as a copper sulfide-containing mineral. The method forms a heap of the mined ore or extends an existing heap by adding the mined ore to the heap. The method also leaches the metal from the mined ore in the heap with an acidic leach liquor and produces a pregnant leach liquor containing the metal in solution. Pyrite that is already in the mined ore generates acid and heat that facilitates leaching metal from the mined ore. The mined ore may be run-of-mine (ROM) ore that is transferred directly from the mine to the heap without changing the size of ore particles in the mined ore.

### TECHNICAL FIELD

The present invention relates to a method of heap leaching a metal, such as copper or nickel or zinc or cobalt, from a mined ore that contains a metal sulfide-containing material, such as a metal sulfide mineral, and recovering the metal from the ore.

The invention relates particularly, although by no means exclusively, to heap leaching run-of-mine (“ROM”) ore, i.e. ore that has been mined and then transferred (directly or via a stockpile) to a heap of ore without further size reduction being carried out on the ore beyond that occurring during mining.

The invention is not confined to heap leaching ROM ore as described in the preceding paragraph and extends to heap leaching ROM ore that has undergone further size reduction beyond that occurring during mining before being transferred to a heap.

The present invention also relates to a heap leaching operation.

The present invention also relates to a method of mining an ore and heap leaching the ore.

### BACKGROUND ART

The technical field of the invention is the production of a metal, such as copper or nickel or zinc or cobalt, from a metal sulfide-containing material, such as a metal sulfide mineral, in a mined ore.

The following description of the invention focuses on copper as one example of a metal in a metal sulfide-containing material, such as a metal sulfide mineral.

Copper is an increasingly important metal for the transition to a low carbon-based global economy.

There are substantial capital and operating cost pressures on mine operators of well-established and new copper mines (which term includes mines in which copper is the only metal recovered and mines in which copper and other valuable metals such as gold are recovered) that have lower average concentrations of copper in copper sulfide-containing materials, such as copper sulfide-containing minerals, than was previously the case.

In many instances, the problem of lower copper concentrations in copper sulfide-containing materials, such as copper sulfide-containing minerals, is compounded by the copper being in more refractory copper sulfide-containing minerals, such as chalcopyrite, than previously, with these minerals being more difficult and expensive to process to recover copper from the minerals.

Mining companies are also very conscious of the importance of operating mines with minimal environmental impact over short and longer terms.

The economics facing copper mine operators mean that there are substantial amounts of copper sulfide-containing material, including mined material and processed forms of mined material (i.e., comminuted material), that are non-economic to recover copper from using recovery options available before the invention was made and therefore are not processed to recover copper from copper sulfide-containing material.

The above description is not an admission of the common general knowledge in Australia or elsewhere.

### SUMMARY OF THE DISCLOSURE

The invention was made as part of a research and development project of the applicant on leaching copper from mined ores that contain copper sulfide containing material, particularly copper sulfide minerals.

The research and development project is focused particularly, although not exclusively, on leaching copper from chalcopyrite (CuFeS₂), hereinafter referred to as “chalcopyrite ores”, because it is known that it is difficult to obtain high copper recoveries from chalcopyrite ores and chalcopyrite ores are a significant source of copper.

The research and development project has produced a number of inventions, summarised below:

1. International Applications PCT/US2021/043869 (WO 2022/026810) and PCT/US2021/043869 (WO 2022/026826). The specifications disclose the impact of pyrite augmentation on bioleaching of an agglomerated copper-containing mined material.

2. International Applications PCT/AU2016/051024 (WO2017/070747) and PCT/AU2018/050316 (WO 2018/184071). The specifications disclose the impact of silver augmentation on bioleaching of an agglomerated copper-containing mined material. The specification of International Application PCT/AU2018/050316 (WO 2018/184071) also discloses an activation agent that activates silver whereby the silver enhances copper extraction from copper-containing mined material.

3. International Application PCT/AU2019/050383 (WO2019/213694). The specification discloses the impact on the dissolution of copper from copper minerals in copper-containing mined material or concentrates of the material of additives (such as thiourea) that form complexes between (a) sulfur, that originated from copper minerals in the ores, and (b) the additives.

The disclosures in the patent specifications of the above International Applications are incorporated herein by cross-reference.

Further work in the research and development project has recognized that a method of heap leaching mined ores as described herein (including, although not limited to run-of-mine (“ROM” ores)) is a viable opportunity that has a number of important advantages.

Heap leaching mined ores, including but not limited to ROM ores, in accordance with the invention is a different approach to heap leaching agglomerates of mined material, as is the focus of the above International Applications.

In broad terms, the invention provides a method of heap leaching a metal from a mined ore, as described herein, from a mine that contains a metal sulfide-containing material, such as a metal sulfide mineral, that comprises:
(a) forming a heap of the mined or extending an existing heap by adding the mined ore to the heap; and
(b) leaching the metal from the mined ore in the heap with an acidic leach liquor, with pyrite already in the mined ore generating acid and heat that facilitate leaching the metal from the mined ore, and producing a pregnant leach liquor containing the metal in solution.

The term “mined ore” is understood herein to include ore that is mined (i.e. “ROM” ore) and transferred from the mine:
i. directly to the heap; or
ii. directly to a stockpile and then transferred later directly to the heap; or
iii. to an intermediate processing operation as described herein and then transferred to the heap; or
iv. to an intermediate processing operation as described herein and then transferred to a stockpile and then transferred later to the heap; or
V. to a stockpile and then transferred to an intermediate processing operation as described herein and then transferred to the heap; or
vi. a combination of the preceding options iv and v with intermediate processing operations before and after the stockpile.

The term “intermediate processing operation” is understood herein to include one or more processing operations that change the size of ore particles, such as by (a) size reduction of mined ore, such as by crushing and grinding operations or (b) agglomeration of fines in mined ore or (c) agglomeration of size-reduced particles from option (a).

The term “intermediate processing operation” does not include the addition of additives, such as microbes, pyrite (such as in the form of a concentrate, acid/raffinate, and other additives described below to mined ore or mined ore that has been subjected to intermediate processing operations before the heap is formed. The invention extends to the addition of such additives to mined ore per se and to mined ore that has been subjected to intermediate processing operations.

As noted above, the invention is concerned particularly with mined ore of options i and ii, i.e. ROM ore that is transferred directly from the mine to the heap or transferred directly from the mine to a stockpile and then transferred later directly from the stockpile to the heap, in both instances without being processed in intermediate processing operations.

The method may also comprise collecting the pregnant leach liquor from the heap and recovering the metal from the pregnant leach liquor.

The method may also comprise transferring a raffinate produced when the metal is recovered from the pregnant leach liquor to the leach step (b).

Heap forming step (a) may comprise forming the heap of the mined ore with additional pyrite to that in the mined ore or extending an existing heap by adding the mined ore and additional pyrite to that in the mined ore to the heap.

Pyrite is important for acid generation and heat generation.

Pyrite generates heat within the heap via reactions in the heap, including reactions with the leach liquor.

It is desirable to reach a target heap temperature quickly to generate cash flow. It is also desirable to maintain a substantially constant heap temperature with time. Temperature variations can have an impact on copper extraction rates and microbe health (in situations where microbes are in a heap).

Typically, higher heap temperatures produce higher copper extraction rates.

When microbes are in a heap, microbe health may be impacted by temperatures above or below a target temperature range and, therefore, it is important to take this into account when selecting a target heap temperature.

The method may comprise selecting the amount of additional pyrite for the heap to reach a target temperature quickly, i.e., in ≤500 days, more typically in ≤400 days, and more typically in ≤300 days.

The target temperature will depend on a range of factors in any given situation. These factors may include any one or more than one of the type of microbes, ore mineralogy, ore grade, acid dose rates, and pH of the leach liquor, etc.

The target temperature, expressed as an average heap temperature, may be in a range of 60-80° C.

The method may comprise adding additional pyrite to a top of the heap during the course of the heap leaching step (b).

The method may comprise adding additional pyrite to the mined ore before forming the heap in heap forming step (a).

For example, the method may comprise adding additional pyrite to the mined ore as the mined ore is being transported from the mine or to a stockpile or from the stockpile to the heap, such as in haul vehicles (such as haul trucks) or conveyors.

By way of further example, the method may comprise adding additional pyrite to the mined ore in a stockpile.

By way of further example, the method may comprise adding additional pyrite to the mined ore as the mined ore is being added to the heap.

By way of further example, the method may comprise blending together the mined ore and additional pyrite and then adding the blend to the heap.

Typically, the mined ore contains pyrite.

The total pyrite, i.e., the total of the pyrite in the mined ore and the additional pyrite, may be 1-10 wt. % of the total mass of the mined ore and the additional pyrite.

The additional pyrite may be obtained from any suitable source.

The additional pyrite may be in any suitable form, noting that an important consideration is whether the pyrite is in a form that can react beneficially in the heap.

The pyrite may be in the form of a pyrite concentrate.

The method may comprise sourcing the additional pyrite from the mine or another mine.

The method may comprise sourcing the additional pyrite from tailings from a tailings dam or an ore processing plant of the mine.

The method may comprise sourcing the additional pyrite from tailings from a tailings dam or an ore processing plant of the other mine.

The method may comprise selecting the amount of the added pyrite to be below a threshold total pyrite concentration for the pyrite in the ore and the additional pyrite.

The threshold total pyrite concentration may be in a range of 1-10 wt. % of the total of the mined ore and additional pyrite. The selection of the threshold total pyrite concentration in any given situation will depend on a range of factors. For example, if the mined ore contains a lot of secondary metal sulfides and is located in a warm/hot climate, the threshold total pyrite concentration may be at or towards the lower limit of 1 wt. %.

There may be situations where there is enough pyrite in the mined ore to make pyrite concentrate addition unnecessary. For example, if the mined ore already contains the required threshold total pyrite concentration, there may be no need to add additional pyrite. However, additional pyrite may be added in this situation to enable a target temperature to be reached more quickly than would otherwise be the case. This would particularly be the case in situations where the additional pyrite has a fine particle size and is therefore readily able to react with mined ore.

The leach liquor may be any suitable acidic leach liquor.

By way of example, the acidic leach may be a raffinate in a situation where copper is recovered from the pregnant leach liquor in heap leach step (b).

An example of a suitable acid is H₂SO₄.

The method may comprise controlling the acid concentration in the heap to an acid dose rate of less than 100 kg H₂SO₄/dry t ore, typically less than 50 kg H₂SO₄/dry t ore, typically less than 30 kg H₂SO₄/dry t ore and may be less than 10 kg H₂SO₄/dry t ore or less than 5 kg H₂SO₄/dry t ore. Typically, the acid dose rate is 1-20 kg H₂SO₄/dry t ore.

The leach liquor may comprise microbes for oxidising ferrous ions and oxidising solid and soluble sulfur compounds, thereby regenerating ferric ions and protons.

The microbes may be any suitable microbes.

The microbes may be any microbes that can oxidise ferrous iron and/or sulfur compounds and include, but are not limited to, members of the bacterial genera Acidithiobacillus, Leptospirillum, Sulfobacillus and Ferrimicrobium, and the archacal genera Acidianus, Acidiplasma, Ferroplasma, Metallosphaera and Thermoplasma.

Typically, the microbes are a diverse population, including microbes selected from mesophiles, moderate thermophiles and thermophiles psychrotolerant or mesophilic or thermophilic (moderate or extreme) bacteria or archaea. The microorganisms may be acidophilic bacteria or archaea. The microorganisms may be thermophilic acidophiles. A diverse population allows activity across a range of operating conditions, including low pH conditions and high sulfate concentrations.

The method may comprise adding other additives (in addition to microbes and pyrite described above) to enhance metal extraction from the heap.

In a situation where the metal is copper, the other additives may comprise silver, such as in the form of silver chloride, silver nitrate or silver sulfate. As noted above, International Applications PCT/AU2016/051024 (WO2017/070747) and PCT/AU2018/050316 (WO 2018/184071) disclose the impact of silver augmentation on bioleaching of a copper-containing mined material.

In a situation where the metal is copper, the other additives may comprise an activation agent to activate silver, selected from thiourea, chlorides, bromides and iodides. As noted above, International Application PCT/AU2018/050316 (WO 2018/184071 discloses activation agents that activate silver whereby the silver enhances copper extraction from copper-containing mined material.

In a situation where the metal is copper, the other additives may comprise a complexing agent (such as thiourea and carbamide phosphate—as disclosed in U.S. Pat. No. 3,679,397, the entire disclosure of which is incorporated into the specification) to enhance the dissolution of copper by forming complexes between (a) sulfur, that originated from copper minerals in the copper-containing mined material, and (b) the complexing agent. As noted above, International Application PCT/AU2019/050383 (WO2019/213694) discloses the impact on the dissolution of copper from copper minerals in copper-containing mined material or concentrates of the materials of such additives.

The other additives may be added in any suitable way to the heap.

For example, the other additives may be added during heap construction or periodically onto a top surface of the heap or in the leach liquor.

By way of further example, the other additives may be added to the mined ore before forming the heap in heap forming step (a).

For example, the method may comprise adding the other additives to the mined ore is being transported from the mine or to a stockpile or from the stockpile to the heap, such as in haul vehicles (such as haul trucks) or conveyors.

By way of further example, the method may comprise adding the other additives to the mined ore in a stockpile.

By way of further example, the method may comprise adding the other additives to the mined ore as the mined ore is being added to the heap.

By way of further example, the method may comprise blending together the mined ore and the other additives and then adding the blend to the heap.

Heap forming step (a) may comprise extending the existing heap by adding the mined ore and additional pyrite to form another vertical lift of the heap.

Heap forming step (a) may comprise extending the existing heap by extending a length or a width of the heap.

Heap leaching step (b) may comprise supplying air to the heap via forced aeration.

Heap leaching step (b) may comprise supplying air to the heap via natural circulation of air from outside the heap into the heap.

The method may comprise monitoring heap parameters selected from any one or more than one of heap temperature, leach liquor irrigation rate, aeration rate, pH of the leach liquor, Eₕ of the leach liquor, the population of microbes, copper extraction rate, etc., and adjusting any one or more than one of the parameters to maintain target heap conditions.

The target heap conditions in any given situation will be a function of a number of factors, including ore mineralogy, climate conditions, availability and cost of additives, such as additional pyrite, etc.

The metal may be any suitable metal that forms soluble metal sulfate complexes.

Examples of suitable metals are copper, nickel and zinc and cobalt.

When the metal is copper, the metal sulfide-containing material may be a copper sulfide-containing material.

The copper sulfide-containing material may be any suitable copper sulfide-containing material, such as a copper sulfide mineral, such as chalcopyrite.

The mined ore may have any suitable copper grade, i.e., concentration of copper in the ore.

By way of example, the mined ore may have an average copper concentration of ≤1.5% by weight (wt. %), typically ≤1.2 wt. %, and more typically ≤1.0 wt. %.

The mined ore may have low copper grades.

The mined ore may have copper grades that are considered to be too low grade to be economically processed in flotation and other wet processing systems for recovering copper from the ores and concentrates of the ores.

The term “low grade” as used in relation to ores containing copper sulfide-containing material is understood herein to be a term that is dependent on currently available technology and the current price of copper, and that material currently considered “low grade” may be considered valuable material in the future depending on technological developments and the future price of copper. The term “low grade” has a similar meaning as applied to nickel and zinc and cobalt mentioned above.

More particularly, the copper sulfide-containing material may be in mined ores that are too low-grade to be economically processed by any conventional processing method.

By way of context, the term “low concentrations of copper” is understood to mean an average copper concentration of ≤0.9 wt. %, typically ≤0.7 wt. %, typically ≤0.5 wt. %, more typically ≤0.3 wt. %, even more typically ≤0.2 wt. %, even more typically ≤0.1 wt. %.

The mined ore may be in any suitable form for the heap leaching step (b).

The mined ore may be a ROM ore that has a particle size in a range between a P80 of 200 mm and a P80 of 30 mm, typically in a range between a P80 of 100 mm and a P80 of 50 mm.

The mined ore may be ROM ore that has any suitable particle shape, noting that particle size ranges described in the preceding paragraph are based on one dimension only.

The method may comprise comminuting the mined ore and producing a suitable particle size distribution for the heap leaching step (b).

The comminuting step may comprise crushing the mined ore in one or more than one comminution circuit that reduces the size of the material.

The comminuting step may comprise crushing the mined ore in a primary comminution circuit, as this term is understood by persons in the copper mining industry.

The comminuting step may comprise crushing the mined ore successively in primary and secondary circuits, as these terms are understood by persons in the copper mining industry.

The comminuting step may comprise crushing the mined ore successively in primary, secondary and tertiary comminution circuits, as these terms are understood by persons in the copper mining industry.

The comminuting step may comprise single or multiple crushing steps delivering crushed mined ore with a suitable particle size distribution for the heap leaching step.

The comminuted ore may have any suitable size.

For example, the comminuted ore may have a particle size in a range between a P80 of 5 mm and a P80 of 30 mm.

The method may comprise selecting a mining method to form the mined ore in a suitable form, including particle size distribution and/or particle shape, for the heap leaching step.

1. The present invention also provides a method of heap leaching copper from a mined ore from a mine that contains a copper sulfide-containing material comprises:
(a) forming a heap of the mined ore or extending an existing heap by adding the mined ore to the heap;
(b) adding additional material (additives) to the heap that comes from one or more than one or all of the following:
   i. additional pyrite to that in the mined ore;
   ii. silver;
   iii. an activation agent to activate the added silver or natural silver in the mined ore;
   iv. a complexing agent to enhance the dissolution of the copper sulfide in the mined ore by forming complexes between (a) sulfur, that originated from the copper sulfide-containing material in the mined ore and (b) the complexing agent; and
(c) leaching copper from the mined ore in the heap with an acidic leach liquor.

The present invention also provides a heap leaching operation for leaching a metal from a mined ore containing a metal sulfide-containing material, such as a metal sulfide mineral, in accordance with the above-described heap leaching method, the heap leaching operation comprising:
(a) a heap of the mined ore and additional pyrite; and
(b) a system that (i) supplies an acidic leach liquor and microbes to the heap so that the leach liquor flows downwardly though the heap and leaches the metal from the ore and (ii) collects a pregnant leach liquor containing the metal in solution from the heap, with the pyrite generating acid and heat in the heap that facilitates leaching the metal from the mined ore, and with the microbes oxidising ferrous ions and oxidising solid and soluble sulfur compounds, thereby regenerating ferric ions and protons.

In broad terms, the invention also provides a method of mining an ore and heap leaching the mined ore comprising:
(a) mining an ore containing a metal sulfide-containing material; and
(b) the above-described heap leaching method.

The above-described heap leaching method, heap leaching operation, and mining method have the following advantages:
Heap leaching mined ore facilitates comparatively quick heap construction and therefore minimises the time delay to generating a cash flow.
The method makes it possible to extract a metal such as copper or nickel or zinc or cobalt from a mined ore that has been categorized by a mine operator as being “non-economic” from the perspective of recovering the metal from the ore.
When any additional pyrite is sourced from the (or another) mine, the method makes it possible to process tailings that contain pyrite and thereby reduce the volumes of existing tailings dams. This is an important environmental outcome.
The acid and heat generating capacity of pyrite (whether already in the mined ore or as additional pyrite) is an advantage in heap leaching and, for example, can reduce the amount of added acid that is required in the leach liquor.
Moreover, the acid-generating capacity of pyrite means that any additional pyrite is used beneficially in the leach step and results in a net reduction in pyrite, which is significant from an environmental perspective.
The method can be operated with readily-available and tried and tested equipment.
The method makes it possible to process what has been previously classified as “waste” ore and reduce the environmental impact of these materials as well as optimising the recovery of value from the mined ore.

### BRIEF DESCRIPTION OF THE DRAWING

The invention is described further below by way of example only with reference to the following Figures, of which:

FIG. 1 is a flow sheet of one embodiment of a method of heap leaching a copper sulfide-containing ore in accordance with the invention;

FIG. 2 is a flow sheet of another embodiment of a method of heap leaching a copper sulfide-containing ore in accordance with the invention; and

FIGS. 3-5 are graphs indicating the results of modeling work in relation to a generic method of heap leaching a copper sulfide-containing ore in accordance with the invention.

### DESCRIPTION OF EMBODIMENT

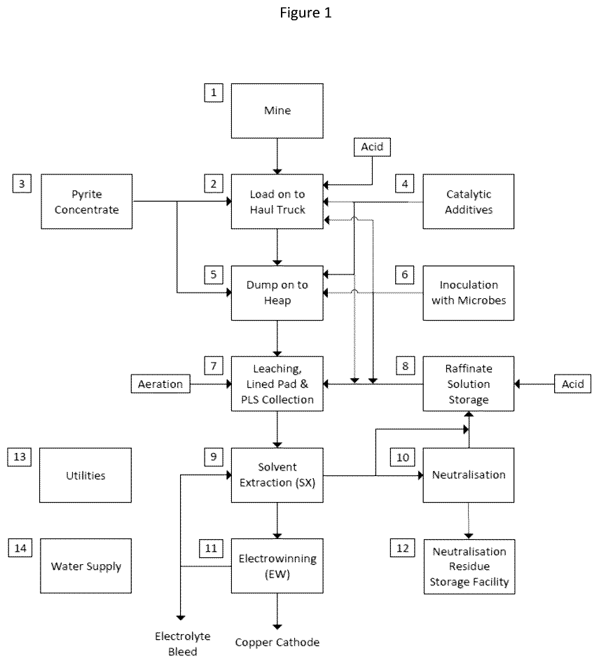

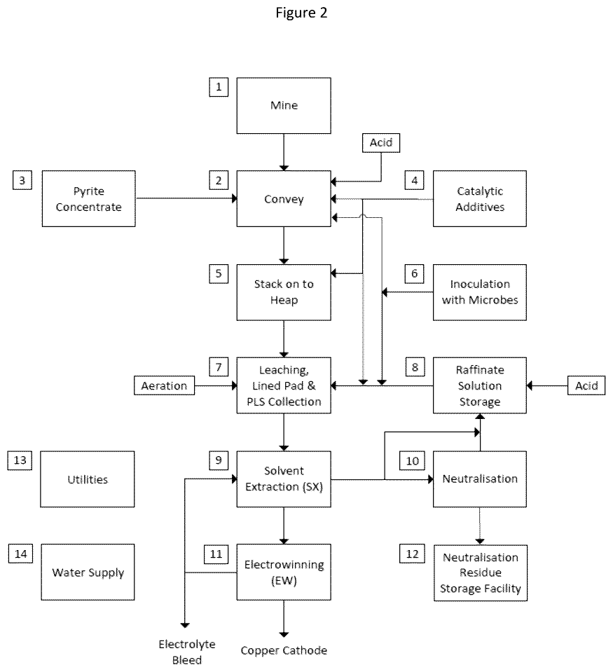

### FIGS. 1 and 2—General

The embodiments of the invention in FIGS. 1 and 2 are described in the context of recovering copper from mined ores that contain copper sulfide-containing material, specifically copper sulfide minerals, such as chalcopyrite.

It is noted that the invention is not confined to copper and extends to other metals such as nickel or zinc or cobalt, in metal sulfide-containing materials, such as metal sulfide minerals, in a mined ore.

The embodiments of the invention described below in relation to FIGS. 1 and 2 are based on microbial-assisted heap leaching mined ores with selected additives (described below) for time periods of up to 35-40 years. The invention is not limited to microbial-assisted heap leaching and to this time period.

In general terms, each embodiment shown in FIGS. 1 and 2 is a method of mining an ore and recovering copper from copper sulfide minerals in the mined ore, comprising:
(a) mining and optionally stockpiling a mined ore containing copper sulfide minerals (such as chalcopyrite);
(b) forming a heap of the mined ore and optionally a pyrite concentrate (or any other form of additional pyrite to that in the mined ore) or extending an existing heap by forming a new lift or increasing the length and/or width dimensions of the existing heap by adding the mined ore and optionally the pyrite concentrate (or any other form of additional pyrite to that in the mined ore);
(c) leaching copper from the mined ore in the heap with an acidic leach liquor and microbes;
(d) optionally enhancing copper extraction from the mined ore with one or more than one other additives, such as silver, silver activation agents, and complexing agents described further below;
(e) recovering a pregnant leach liquor containing copper in solution from the heap;
(f) recovering copper from the pregnant leach liquor via a solvent extraction system; and
(g) regenerating a raffinate produced when copper is recovered from the pregnant leach liquor and transferring the raffinate to the heap.

Typically, the mined ore has a low copper grade of ≤0.9 wt. %, typically ≤0.8 wt. %, more typically ≤0.7 wt. %, more typically ≤0.5 wt. %, even more typically ≤0.3 wt. %, even more typically ≤0.1 wt. %. The invention also extends to mined ores having higher copper concentrations.

In addition, the embodiments of the method of recovering copper from mined ore containing copper sulfide-containing material, specifically copper sulfide minerals, such as chalcopyrite, in accordance with the invention shown in FIGS. 1 and 2 are described in the context of the pyrite being a pyrite concentrate extracted from mine tailings. The invention extends to other forms of additional pyrite.

It is understood that the invention is not confined to these embodiments and extends generally to any suitable copper-containing ore and to any suitable source of pyrite.

### Microbial-Assisted Heap Leaching

The extraction of copper from mined ores containing copper sulfide minerals, such as chalcopyrite, requires an oxidant and an acid.

Industrially, ferric ions are used as an oxidant, and sulfuric acid is used as an acid. During the process of mineral dissolution, ferric ions are reduced to ferrous ions and sulfuric acid is consumed during reactions with gangue minerals.

Microorganisms oxidise ferrous ions, regenerating ferric ions, as well as oxidising solid and soluble sulfur compounds, generating sulfuric acid.

Maintaining sufficient rates of iron and sulfur oxidation to facilitate optimal copper extraction requires a microbial population supplied with an inhabitable environment and any required nutrients.

The mechanisms of dissolution of copper sulfide minerals in mined ores depend on the presence of ferric ions and acid to break down the mineral matrix and solubilise metals. Ferric ions and acid are consumed during mineral oxidation, and dissolution rates will decrease unless they are replenished.

Under aerobic conditions, microbes regenerate ferric ions and acid through biological oxidation of ferrous ions and reduced sulfur compounds:

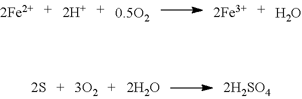

The sulfur may be derived from oxidation of sulfides or as an addition.

Not only do these reactions maintain concentrations of ferric ions and acid, they also generate energy, potentially making the process autocatalytic under conditions ideal for microbial reproduction.

During mineral dissolution of copper sulfide minerals in mined ores, changing solution conditions impact the activity of microbes present in the leaching environment.

The applicant has found that the rate of ferrous ion and sulfur oxidation is affected by high metal concentrations, fluctuations in solution pH and changes in temperature.

Sulfide mineral dissolution (and therefore copper extraction of copper sulfide minerals in mined ores can be negatively impacted if ferric ions and acid are not regenerated through microbial activity at a sufficient rate.

### FIG. 1—Description

Ore is mined in a mine 1 and loaded onto haul trucks 2 (or other suitable vehicles) and transported directly to a heap 5 without intermediate processing such as comminution or agglomeration.

The mined ore may be ROM ore that is transported directly from the mine 1 to a stockpile (not shown) and then transported directly to the heap 5, without intermediate processing such as comminution or agglomeration.

It is noted that the invention also extends to ROM ore that has been subjected to intermediate processing such as comminution or agglomeration before the ore is in the heap 5.

The heap 5 may be a new heap, with the mined ore being used to construct the heap 5.

The heap 5 may be an existing heap, with the mined ore being used to create a new vertical lift or to extend the length and/or width dimensions of the heap 5.

The heap may be of any suitable construction.

By way of example, the heap 5 may include:
(a) a leach liquor storage and delivery system 8 to supply the leach liquor to an upper surface of the heap;
(b) an outer cover (not shown), such as a thermofilm, for at least the sides of the heap to assist in temperature control in the heap;
(c) an aeration system 7 for example comprising a blower and pipework for supplying air from the blower to the interior of the heap;
(d) a pregnant leach liquor collection system (not shown) for collecting leach liquor containing copper in solution that is extracted from copper sulfide-containing materials in agglomerates in the heap; and
(e) microbes 6 or other suitable oxidants for oxidising ferrous ions and oxidising solid and soluble sulfur compounds, thereby regenerating ferric ions and protons.

When additional pyrite over and above that already in the mined ore is required, a predetermined amount of a pyrite concentrate 3 (or other suitable form of pyrite) is added to the haul trucks 2 and/or the heap 5. The amount of the pyrite concentrate 3, if required, is determined in any given situation, including during the course of the heap leaching step (b), having regard to a range of parameters including, but not limited to, the concentration of pyrite in the pyrite concentrate 3, the amount of pyrite in the mined ore, the mineralogy of the mined ore, a target copper extraction rate, a target heap temperature, a target ramp-up time to the target heap temperature, the leach conditions, including Eₕ of the acidic leach liquor and/or the irrigation rate, the type and population of microbes in the heap, and other additives 4 (described below) added to the haul trucks 2 or the heap 5. The assessment may include monitoring any one or more than one of the parameters mentioned above.

A predetermined population of microbes 6 is added to the mined ore in the haul trucks 2 or in the heap 5 or in the leach liquor for the heap 5, including during the course of the heap leaching step (b). The population required in any given situation is determined having regard to the parameters described in the preceding paragraph. The selection of the location of the addition of microbes 6 can be determined having regard to assessment of operating conditions during the course of heap leaching mined ore. The assessment may include monitoring any one or more than one of the parameters mentioned above.

Optionally, predetermined amounts of one or more than one other additives, collectively referred to as the numeral 4 in FIG. 1, such as silver, silver activation agents, and complexing agents, for enhancing copper extraction from the mined ore may be added as described below.

First, a predetermined addition of silver 4, for example in the form of silver chloride, silver nitrate or silver sulfate may be added to the mined ore in the haul trucks 2 or to the heap 5 or in the leach liquor for the heap, including during the course of the heap leaching step (b). The selection of the location of the addition of silver 4 can be determined having regard to assessment of operating conditions during the course of heap leaching mined ore. The assessment may include monitoring any one or more than one of the parameters mentioned above. As noted above, International Applications PCT/AU2016/051024 (WO2017/070747) and PCT/AU2018/050316 (WO 2018/184071) disclose the impact of silver augmentation on bioleaching of an agglomerated copper-containing mined ore.

In addition, a predetermined addition of an activation agent 4 to activate silver, for example selected from thiourea, chlorides, bromides and iodides may be added to the mined ore in the haul trucks 2 or to the heap 5 or in the leach liquor for the heap, including during the course of the heap leaching step (b). The selection of the location of the addition of the activation agent can be determined having regard to assessment of operating conditions during the course of heap leaching mined ore. The assessment may include monitoring any one or more than one of the parameters mentioned above. As noted above, International Application PCT/AU2018/050316 (WO 2018/184071 discloses activation agents that activate silver whereby the silver enhances copper extraction from copper ores.

Further, a predetermined addition of additives 4, such as thiourea and carbamide phosphate (as disclosed in U.S. Pat. No. 3,679,397), that form complexes between (a) sulfur, that originated from copper minerals in the ores, and (b) the additives may be added to the mined ore in the haul trucks 2 or to the heap 5 or in the leach liquor for the heap, including during the course of the heap leaching step (b). The selection of the location of the addition of such additives can be determined having regard to assessment of operating conditions during the course of heap leaching mined ore. The assessment may include monitoring any one or more than one of the parameters mentioned above. As noted above, International Application PCT/AU2019/050383 (WO2019/213694) discloses the impact on the dissolution of copper from copper minerals in ores or concentrates of ores of such additives.

A predetermined amount of a suitable acid, such as sulfuric acid, may also added to the mined ore in the haul trucks 2 or in the leach liquor for the heap, including during the course of the heap leaching step (b). The selection of the location of the acid addition and the dose rate can be determined having regard to assessment of operating conditions during the course of heap leaching mined ore. The assessment may include monitoring any one or more than one of the parameters mentioned above.

The pregnant leach liquor from the heap 5 is processed in a solvent extraction system 9 that extracts copper from the liquor in an organic medium and then strips copper from the organic medium and produces a copper-containing solution. The invention extends to any suitable copper recovery systems.

The copper-containing solution is transferred to an electrowinning plant 11 and copper is recovered from solution.

A raffinate from the solvent extraction system 9 is regenerated and transferred to the leach liquor storage and delivery system 8 and returned to the heap as leach liquor. Make-up acid is also added to the leach liquor storage and delivery system 8, as required.

The leach liquor regeneration system includes a raffinate bleed limestone/lime neutralization 10 to control the build-up of impurities, generating neutralized solids for separate impoundment or possibly co-impoundment with tailings.

The pyrite-containing concentrate that is in the heap 5 provides valuable sources of (a) acid via the pyrite and (b) heat in the heap 5.

The acid-generating properties of the pyrite mean that the amount of acid that has to be added to the leach liquor can be reduced to maintain a given leaching acid requirement.

In addition, the microbial oxidation of pyrite produces acid and heat, all of which are beneficial for heap leaching the copper sulfide-containing material.

As noted above, the pyrite may be sourced from mine tailings. This option is described in the above-mentioned International Applications PCT/US2021/043869 (WO 2022/026810) and PCT/US2021/043869 (WO 2022/026826), and the disclosure in these International Applications is incorporated herein by cross-reference.

For example, the pyrite may be in tailings from a tailings dam or an ore processing plant of the mine.

By way of further example, the pyrite may be obtained as a pyrite concentrate by removing pyrite from a pyrite-containing slurry from a tailings dam or an ore processing plant of the mine.

The pyrite removal step may include floating pyrite-containing particles in the pyrite-containing slurry and producing (i) an inert stream as one flotation output and (ii) a pyrite-containing material stream, such as a pyrite-containing concentrate stream, as another flotation output.

The pyrite removal step may include, before the above flotation step, a size separation step, such as via cyclones or other suitable classification devices, that for example separates larger particles from the pyrite-containing slurry, with the remaining pyrite-containing slurry being transferred to the flotation step.

The pyrite removal step may include reducing the size of the larger particles in a size reduction circuit and returning the reduced-sized particles to the size separation step.

### FIG. 2—Description

The embodiment described in relation to FIG. 2 is substantially the same as the embodiment described in relation to FIG. 1 and the same reference numerals are used for both Figures.

The difference between the embodiments is that the FIG. 2 embodiment uses a conveyor system to transport mined ore from the mine 1 to a heap 5 and an ore stacking system (not shown) being used to distribute mined ore onto the heap 5.

The FIG. 2 embodiment is particularly suitable for situations in which the mined ore from the mine 1 has a size range that is not too large and can be transported on the conveyor system.

### Heap Leaching Methodology

The above description of the embodiments shown in FIGS. 1 and 2 provides details of the methodology for operating the described embodiments.

As described below, the viability of heap leaching ROM ore sourced directly from a mine or via a stockpile, without intermediate processing such as comminution or agglomeration, has been established in the modelling work described below.

The results of the modelling work described below provide a basis for a mine operator to establish target operating conditions for a heap leach operation in any given situations and operating procedures to start up heap leaching operations quickly and to maintain operations of the heaps during the life of the heaps.

In relation to start-up, the method may include selecting the amount of the additional pyrite in the heap and the type of pyrite addition (such as selecting fine-sized pyrite concentrates) to optimize heat generation in the heap.

The target heap conditions in any given situation will be a function of a number of parameters, including ore mineralogy, climate conditions, microbes, acid selection, the selection, availability and cost of additives (such as additional pyrite, silver, activation agents for silver, and complexing agents described above), target copper extraction rate, and economic factors such as operating costs including reagent costs.

After the heap has reached a target temperature (determined having regard to the selection of operating parameters such as microbes, ore mineralogy, leach liquor, and other factors), the method comprises monitoring heap parameters selected from any one or more than one of heap temperature, leach liquor irrigation rate, aeration rate, pH of the leach liquor, Eₕ of the leach liquor, the population of microbes, other additive selections and addition rates, copper extraction rate, etc., and adjusting any one or more than one of the parameters to maintain target heap conditions.

Adjustments to heap parameters will inevitably be necessary with changes in mineralogy and size of ROM ore and climate changes, etc.

The required adjustments can be determined for example by operator judgment having regard to reviewing the monitored parameters, and the adjustments may be made for example by adjusting irrigation rates, aeration rates, pyrite and other additive addition rates.

The required adjustments can be determined for example by automated control to bring heap conditions to set points established prior at heap start-up having regard to modelling work for the heap. Again, the adjustments may be made for example by adjusting irrigation rates, aeration rates, pyrite and other additive addition rates.

The required adjustments can be determined for example by automated control to bring heap conditions to optimal conditions via direct reference to the model for the heap. Again, the adjustments may be made for example by adjusting irrigation rates, aeration rates, pyrite and other additive addition rates.

### Advantages of the Embodiments Shown in FIGS. 1 and 2

The advantages of the above-described embodiments shown in FIGS. 1 and 2, and the invention generally, include the following advantages:
Heap leaching mined ore facilitates comparatively quick heap construction and therefore minimises the time delay to generating a cash flow.
The method makes it possible to extract a metal such as copper or nickel or zinc or cobalt from a mined material that has been categorized by a mine operator as being “non-economic” from the perspective of recovering the metal from the ore.
When any additional pyrite is sourced from the (or another) mine, the method makes it possible to process tailings that contain pyrite and thereby reduce the volumes of existing tailings dams. This is an important environmental outcome.
The acid and heat generating capacity of pyrite (whether already in the mined ore or as additional pyrite) is an advantage in heap leaching and, for example, can reduce the amount of added acid that is required in the leach liquor.
Moreover, the acid-generating capacity of pyrite means that any additional pyrite is used beneficially in the leach step and results in a net reduction in pyrite, which is significant from an environmental perspective.
The method can be operated with readily-available and tried and tested equipment.
The method makes it possible to process what has been previously classified as “waste” material and reduce the environmental impact of these materials as well as optimising the recovery of value from the mine.

### Modelling Work

The applicant has carried out computational fluid dynamics (“CFD”) modelling work on a generic heap of mined ore, i.e., ROM ore, to assess the invention. The applicant modelled a series of scenarios with and without “additives” considered by the applicant to be important to heap leaching performance.

### Generic Heap

The generic heap was created by the applicant from:
Publicly available information.
Information averaged across a range of samples.
Learnings of the applicant from the research and development project described above, including the learnings reported in the above International Applications.
Learnings of the applicant from a CuPER model developed by the applicant.
Standard/industry practice parameters.
The applicant did not rely on confidential information of the applicant that is outside the research and development project.
The CuPER model used by the applicant is a confidential model of the applicant.

### Assumptions for the CFD Model

˜45 Mtpa heap.
Located in the Atacama desert.
   assumed weather conditions for this location.
ROM ore having a P80 of 40 mm.
Multiple lifts.
Each lift having an 18 m lift height.
7 lifts.
A new lift stacked every month (30 days) and leached for 1 year (360 days).
The bottom lift received 7 years total leaching (2520 days).
Quick progression to each successive lift.
The heap was constructed (physical features) and operated (additives such as pyrite) to maintain heap temperature.
   For example, the sides of the heap were completely covered in a thermofilm to minimise heat loss.
Constant mineralogy of ROM ore.
Average of samples having 0.41% CuT, with 74% of the copper as chalcopyrite.
Average of samples having 2.64% pyrite.
Microbes in appropriate quantities.

### Scenarios

The CFD modelling evaluated the following scenarios:
1. Base case
   No additives (including no chloride in solution, due to host rock)
2. Silver+chloride
   0.25 g Ag/kg Cu.
   1 g/L chloride.
3. Pyrite concentrate.
   1% pyrite concentrate augmentation.
4. Thiourea
5. Pyrite concentrate+silver+chloride
   1% pyrite augmentation.
   0.25 g Ag/kg Cu.
   1 g/L chloride.

### CFD Modelling Approach

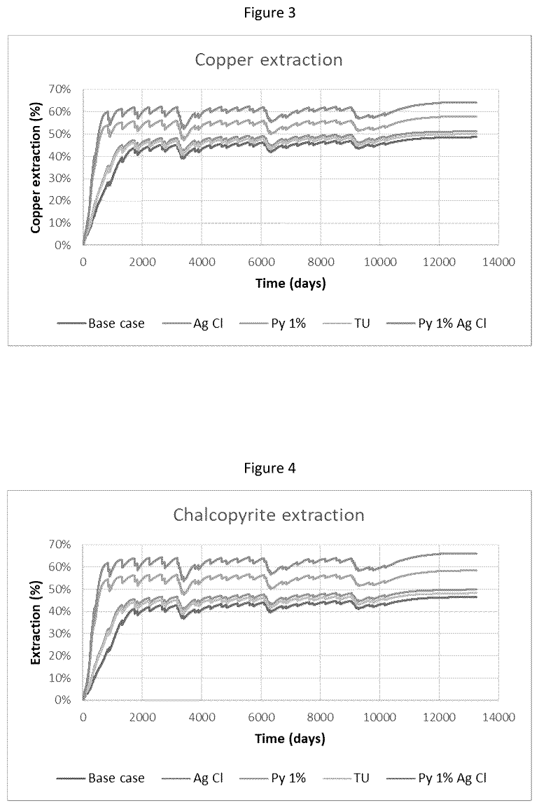

Results shown in FIGS. 3-7 are CFD modelling outputs for the above-described generic heap.
CFD model assumptions were obtained from CuPER modelling carried out by the applicant. Specifically, the applicant relied on:
   CuPER modelling of generic ore, leached for 7 years (equivalent to the bottom lift of the heap) used as inputs to the CFD model.
   CuPER outcomes of rate constants and chalcopyrite passivation used as inputs to the CFD model.
The scenarios were modelled as a newly-constructed and operated heap.
   Comparison of Results from the CFD and CuPER Models
The base case leach performance in the CFD model is better than that in the CuPER model.
   This could be related to the temperatures predicted by the CFD model.
The additive benefit calculated from the CFD model results is slightly less than that calculated from the CuPER model.
The broad trends are the same for the CFD and CuPER models.
There is a good confidence in the complementary use of the two-model approach.

### Results—FIGS. 3-5

The modelling results shown in FIGS. 3-5 are for Lift 1 (leached for a total of 7 years).
The results in FIGS. 3, 4 and 5 support viability of a pyrite concentrate ROM heap.

### Discussion of the Results in FIGS. 3-5

FIG. 3—copper extraction v time
The graph focuses on total copper extraction v time.
Scenario 5 (pyrite concentrate+silver+chloride) resulted in the best copper extraction, with a quick ramp-up to high extractions.
There is a significant difference in copper extractions between Scenario 5 and Scenario 1 (base case), both in terms the actual extractions and the ramp-up times.
   For example, after 1000 days, the Scenario 5 copper extraction was at 60% and the Scenario 1 copper extraction was only 35%.
   By way of further example, from 2000 days onwards, the Scenario 5 copper extraction was at 60% and the Scenario 1 copper extraction was only 40-45%.
Scenario 3 (pyrite concentrate) resulted in the 2^{nd} best copper extraction, with a quick ramp-up to high extractions.

### FIG. 4—Chalcopyrite Extraction v Time

The graph focuses on chalcopyrite extraction v time.
The results follow closely the copper extraction v time plots in FIG. 3, indicating that heap leaching ROM ore is effective for the difficult to leach chalcopyrite mineral.

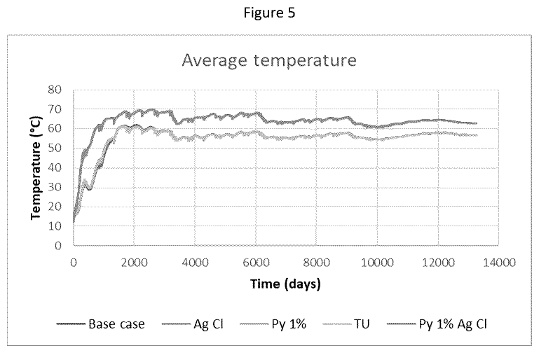

### FIG. 5—Average Temperature v Time

The graph focuses on average heap temperature v time.
Scenario 5 (pyrite concentrate+silver+chloride) resulted in the highest heap temperature, with a quick ramp-up to high extractions.
Note—The plots for Scenarios 1 (base) and 2 (silver+chloride) are in the Figure, although not clearly evident in the Figure. The reason for this is that three lower temperature Scenarios essentially overlap—i.e., Scenarios 1 (base), 2 (silver+chloride), and 4 (TU) and the two higher temperature Scenarios overlap—i.e. Scenarios 3 (pyrite concentrate) and 5 (pyrite concentrate+silver+chloride) overlap.

Many modifications may be made to the embodiments described in relation to FIGS. 1 and 2 without departing from the spirit and scope of the invention.

By way of example, whilst the embodiments described in relation to FIGS. 1 and 2 describe leaching run-of-mine (“ROM”) ores, the invention is not limited to this option and extends to heap leaching ROM ore that has undergone intermediate processing, such as size reduction, before being transferred to a heap.

By way of further example, whilst the embodiments described in relation to FIGS. 1 and 2 include sourcing pyrite concentrate from a mine tailings as described in the above-mentioned International Applications PCT/US2021/043869 (WO 2022/026810) and PCT/US2021/043869 (WO 2022/026826), the invention is not limited to this option and extends to the use of any suitable source of pyrite.

1. A method of heap leaching a metal from a mined ore from a mine that contains a metal sulfide-containing material comprises:
(a) forming a heap of the mined ore or extending an existing heap by adding the mined ore to the heap; and
(b) leaching the metal from the mined ore in the heap with an acidic leach liquor, with pyrite already in the mined ore generating acid and heat that facilitates leaching the metal from the mined ore, and producing a pregnant leach liquor containing the metal in solution.

2. The method defined in claim 1 wherein the mined ore comprises run-of-mine (ROM) ore that is transferred directly from the mine to the heap or directly from the mine to a stockpile and then later directly to the heap, in both instances without being processed in intermediate processing operations.

3. The method defined in claim 1 further comprises collecting the pregnant leach liquor from the heap and recovering the metal from the pregnant leach liquor.

4. The method defined in claim 1 wherein heap forming step (a) comprises forming the heap of the mined ore with additional pyrite to that in the mined ore or extending an existing heap by adding the mined ore and additional pyrite to that in the mined ore to the heap.

5. The method defined in claim 4 comprises selecting the amount of additional pyrite for the heap to reach a target temperature quickly, i.e., in ≤500 days, more typically in ≤400 days, and more typically in ≤300 days.

6. The method defined in claim 5 wherein the target temperature, expressed as an average heap temperature, is in a range of 60-80° C.

7. The method defined in claim 4 wherein the additional pyrite and pyrite in the mined ore, i.e., total pyrite, is 1-10 wt. % of the total mass of the mined ore and the additional pyrite.

8. The method defined in claim 4 wherein the additional pyrite is a pyrite concentrate.

9. The method defined in claim 4 comprises sourcing the additional pyrite from the mine or another mine.

10. The method defined in claim 4 comprises sourcing the additional pyrite from tailings from a tailings dam or an ore processing plant of the mine.

11. The method defined in claim 4 comprises selecting the amount of the additional pyrite to be below a threshold total pyrite concentration for the pyrite in the mined ore and the additional pyrite.

12. The method defined in claim 1 wherein the leach liquor comprises microbes for oxidising ferrous ions and oxidising solid and soluble sulfur compounds, thereby regenerating ferric ions and protons.

13. The method defined in claim 1 comprises adding other additives to enhance metal extraction from the heap.

14. The method defined in claim 13 wherein, in a situation where the metal is copper, the other additives comprise silver and an activation agent to activate silver.

15. The method defined in claim 13 wherein, in a situation where the metal is copper, the other additives comprise a complexing agent to enhance the dissolution of copper by forming complexes between (a) sulfur, that originated from copper minerals in the ore, and (b) the complexing agent.

16. The method defined in claim 13 comprises adding the other additives during heap construction or periodically onto a top surface of the heap or in the leach liquor.

17. The method defined in claim 1 wherein the heap forming step (a) comprises extending the existing heap by adding the mined ore and additional pyrite to form another vertical lift of the heap.

18. The method defined in claim 1 wherein heap forming step (a) comprises extending the existing heap by extending a length or a width of the heap.

19. The method defined in claim 1 wherein heap leaching step (b) comprises supplying air to the heap via forced aeration.

20. The method defined in claim 1 wherein heap leaching step (b) comprises supplying air to the heap via natural circulation of air from outside the heap into the heap.

21. The method defined in claim 1 comprises monitoring heap parameters selected from any one or more than one of heap temperature, aeration rate, Eₕ of the leach liquor, microbes, copper extraction rate, etc., and adjusting any one or more than one of the parameters to maintain target heap conditions.

22. The method defined in claim 1 wherein the metal comprises any one of copper, nickel and zinc and cobalt.

23. The method defined in claim 22 wherein, when the metal is copper, the metal sulfide-containing material comprises a copper sulfide-containing material, such as a copper sulfide mineral, such as chalcopyrite.

24. The method defined in claim 23 wherein the mined ore has an average copper concentration of ≤1.5% by weight, typically ≤1.2 wt. %, and more typically ≤1.0 wt. %.

25. The method defined in claim 1 wherein the mined ore is a ROM ore that has a particle size in a range between a P80 of 200 mm and a P80 of 30 mm, typically in a range between a P80 of 100 mm and a P80 of 50 mm.

26. The method defined in claim 1 comprises comminuting the mined ore and producing a suitable particle size distribution for the heap leaching step (b).

27. The method defined in claim 1 wherein heap comprises selecting a mining method to form the mined ore in a suitable form, including particle size distribution and/or particle shape, for the heap leaching step.

28. A method of heap leaching copper from a mined ore from a mine that contains a copper sulfide-containing material comprises:
(d) forming a heap of the mined ore or extending an existing heap by adding the mined ore to the heap;
(e) adding additional material (additives) to the heap that comes from one or more than one or all of the following:
i. additional pyrite to that in the mined ore;
ii. silver;
iii. an activation agent to activate the added silver or natural silver in the mined ore;
iv. a complexing agent to enhance the dissolution of the copper sulfide in the mined ore by forming complexes between (a) sulfur, that originated from the copper sulfide-containing material in the mined ore and (b) the complexing agent; and
(f) leaching copper from the mined ore in the heap with an acidic leach liquor.

29. A heap leaching operation for leaching a metal from a mined ore containing a metal sulfide-containing material in accordance with the heap leaching method defined in claim 1, the heap leaching operation comprising:
(a) a heap of the mined ore and additional pyrite; and
(b) a system that (i) supplies an acidic leach liquor and microbes to the heap so that the leach liquor flows downwardly though the heap and leaches the metal from the ore and (ii) collects a pregnant leach liquor containing the metal in solution from the heap, with the pyrite generating acid and heat in the heap that facilitates leaching the metal from the mined ore, and with the microbes oxidising ferrous iron to ferric iron.

30. A method of mining an ore and heap leaching the ore comprising:
(a) mining an ore containing a metal sulfide-containing material; and
(b) the heap leaching method defined in claim 1.
